(19) United States
(12) Patent Application Publication
(10) Pub. No.: US 2023/0211272 A1
(43) Pub. Date: Jul. 6, 2023

(54) FILTER ELEMENT, INTERIOR AIR FILTER AND PRODUCTION METHOD

(71) Applicant: MANN+HUMMEL GmbH, Ludwigsburg (DE)

(72) Inventor: Peter PEKNY, Neuenmarkt (DE)

(21) Appl. No.: 18/181,290

(22) Filed: Mar. 9, 2023

Related U.S. Application Data
(63) Continuation of application No. PCT/EP2021/073016, filed on Aug. 19, 2021.

(51) Int. Cl. B01D 46/52; B01D 46/00

(52) U.S. Cl. CPC B01D 46/521; B01D 46/0005

(57) ABSTRACT

A filter element has a fold pack with a filter material folded in a zigzag shape. The fold pack has lateral fold profiles and an end fold section disposed at a head side of the fold pack. Lateral strips are attached to the lateral fold profiles of the fold pack. A seal section angularly projects at an angle away from the end fold section at the head side of the fold pack. The seal section is provided with at least one incision or cutout configured to receive a corresponding filter housing contour. A filter assembly with such a filter element is provided. The filter housing has a housing part with a filter housing contour provided with at least one engagement element. The at least one incision or cutout of the seal section receives the at least one engagement element of the filter housing contour.

### CROSS-REFERENCE TO RELATED APPLICATIONS

This application is a continuation application of international application No. PCT/EP2021/073016, having an international filing date of 19 Aug. 2021 and designating the United States, the international application claiming a priority date of 9 Sep. 2020 based on prior filed German patent application No. 10 2020 123 461.9, the entire contents of the aforesaid international application and the aforesaid German patent application being incorporated herein by reference.

### BACKGROUND OF THE INVENTION

The present invention concerns a filter element. Furthermore, the invention concerns an interior air filter with such a filter element. Still further, the invention concerns a filter assembly or a filter device.

Even though applicable to arbitrary filter elements and filter assemblies, the present invention as well as the problems underlying it will be described in the following for an interior air filter of a motor vehicle.

The increasing air pollution, in particular in metropolitan cities, in connection with the use of modern air conditioning devices makes it necessary to purify by means of suitable filters the air guided from the exterior into the interior of a motor vehicle and processed or air-conditioned. For this purpose, for example, particle filters, odor filters or their combination with each other are conceivable which are to filter or adsorb as much as possible of the suspended substances, particles, and odors contained in the ambient air.

For filtering air for the interior of a motor vehicle, often folded or pleated filter materials, for example, filter nonwovens forming a fold pack, are used. For this purpose, an initially flat filter material sheet is folded in a zigzag shape. The fold pack is held, for example, by lateral strips and head strips or another frame. Such filter elements can be fixed exchangeably in a filter receptacle. The thus formed filter assembly can be installed in an air conditioning device of a corresponding motor vehicle.

EP 1 434 641 B1 discloses a filter element in which tabs projecting laterally from a fold pack are used for sealing in relation to a housing. In this context, such tabs are pushed by engagement means into the fold valleys against the housing. DE 10 2004 054 246 A1 discloses a filter element in which end fold sections of a fold pack are clamped between housing parts.

### SUMMARY OF THE INVENTION

In view of this background, it is the object of the present invention to provide an improved filter element and/or a filter assembly in which in particular a rim-side sealing action can be improved.

Accordingly, a filter element is proposed with a fold pack of filter material folded in a zigzag shape, with lateral strips attached to fold profiles of the fold pack, and with at least one seal section which is projecting from an end fold section at the head side from the fold pack. The seal section comprises at least one incision or cutout which can serve in particular for receiving a corresponding filter housing contour.

Cutout is understood as a closed cut of the seal section while an incision is an open cut.

Due to the seal section which is projecting at the head side, for example, at an angle, an improved sealing action in relation to the housing parts is achieved because the incisions or cutouts enable an easier attachment and therefore reinforcement and positioning of the head side. In comparison to the lateral strips at the longitudinal sides which due to the application on fold profiles exhibit a certain stability, it is desirable to achieve an improved sealing action at the head side, i.e., in the direction of the machine direction of the fold pack. This is possible by means of the seal sections in particular without additional seal devices with material foreign to filters.

Moreover, an interior air filter with such a filter element is proposed. A fresh air filter for the passenger compartment of a motor vehicle is understood in this context as interior air filter. Alternatively, the filter element can also be used in domestic applications, for example, in kitchen exhaust hoods. Further applications will be explained in the following.

In embodiments, the seal section which projects at an angle is part of a head strip which is attached to an end fold section of the fold pack. A flat section which is present between the lateral strips and usually made of a filter material is referred to as a head strip. A tab projecting away from the head strip can then be understood as seal section.

Alternatively or additionally, the seal section can be formed by a projecting end fold section. This has the advantage that no additional manufacturing costs due to the application of the head strip are incurred.

The seal section can project, for example, in case of a cuboid filter element, from a top-side edge. Due to the incisions or cutouts, a precise accommodation in a corresponding filter housing contour, for example, in the manner of engagement elements pushing through the incisions or cutouts, can be achieved. In particular in case of a plurality of incisions or cutouts, the head side is additionally held and stabilized by the interaction with the engagement elements of the filter housing. This leads to an improved sealing action, for example, by a radial compression of the seal section in relation to a seal surface of the housing.

In embodiments, the filter element comprises at least one further seal section which extends at an angle laterally away from one of the lateral strips. Such a further seal section projects in particular from one of the lateral strips and comprises also at least one incision or one cutout. The incision or cutout can be adapted for receiving a corresponding filter housing contour.

In embodiments, the filter element has two head-side seal sections with incisions and/or cutouts and two seal sections which project away from the lateral strips and comprise only optionally incisions or cutouts.

In embodiments, the seal section is formed of a flat material strip. As material strips, in particular the filter material is conceivable in embodiments. Preferably, the filter element is also free of further seal devices, in particular of synthetic foam materials such as PUR or other plastic synthetic materials used as seal materials.

In embodiments, the incision and/or the cutout is formed by a notch, a hole, and/or a stamped-out portion in the material strip. As hole geometries, in particular rectangular, round, but also triangular holes are conceivable, wherein a flexible adaptation to corresponding engagement elements in the filter housing can be made.

In embodiments, the seal section is a section of a lateral strip attached to fold profiles of the fold pack, which section projects laterally past a width and/or a height of the fold pack. In addition or as an alternative, the seal section can be a section of an attached head strip which laterally projects past a length and/or a height of the fold pack. Furthermore, the seal section can be a section of an end fold section which projects laterally past a length and/or a height of the fold pack.

In embodiments, the lateral strip and/or the head strip has an L-profile wherein the shorter section or leg corresponds to the respective seal section. Due to the projecting section, the filter element can be sealed at the head side in relation to a housing with little expenditure.

In embodiments, the seal section projects laterally past a height of the fold pack away from the fold pack. In this context, the angularly projecting seal section can project laterally at a slant and past the height of the fold pack. The seal section can also be folded over so that it pushes laterally resiliently against a housing wall.

In embodiments, the angle at which the seal section is projecting away from the end fold section can be variable, i.e., the seal section comprises a rotational degree of freedom in relation to the end fold section and is essentially jointedly supported. This simplifies mounting at the filter housing in particular when a seal section with cutout (closed cut) is provided.

The filter element is preferably formed exclusively of a filter material, such as a nonwoven material, and an adhesive material required for the attachment of the lateral strips and/or head strips. In embodiments, the filter element is free of additional seal devices attached to the fold pack and/or the seal section, in particular of rubber or synthetic foams.

In addition, a filter assembly with a filter housing and a filter element, as described above or in the following, is proposed. The filter element is at least partially receivable in the filter housing. One can also speak of a filter device.

The filter housing comprises a housing part with at least one engagement element which forms the housing contour corresponding to the incision or cutout.

In embodiments, the incisions or cutouts thus interact in the manner of holes or notches with the engagement elements of the filter housing part which are manufactured in general of synthetic materials. Due to the geometries corresponding which each other in or at the seal section and the filter housing, on the one hand, an improved positioning and thus sealing action between the filter element and the housing is provided, and, on the other hand, the stability, in particular at the head side, can be improved. Since, due to the in particular plurality of incisions and engagement elements, an attachment of the filter element is realized along the head side, it is possible to achieve an improved sealing action by seal ridges of the filter housing engaging about the seal section. In this context, it is not required to insert, for example, an edge of the seal section into a slot. Instead, a sealing action can be achieved by compression of the seal section between housing parts, in particular in axial direction.

In embodiments, the housing part can comprise a seal ridge which pushes against the seal section so that the latter is fastened against the same.

In embodiments, a further housing part with a further seal ridge can be provided. The seal section is then clampable or compressible between the seal ridges in a sealing manner and is held due to the corresponding contours of the incisions or cutouts of the seal section by the engagement elements of the filter housing.

In embodiments, the engagement element or elements can comprise a hook. It is, for example, possible that a plurality of openings in the seal section, which is projecting angularly, are fastened at such hooks which push through the seal section.

The filter element comprises, for example, a filter material and one or a plurality of stabilization elements, in particular in the manner of lateral strips and/or head strips (also referred to as end strips) which stabilize the filter material at least in sections in order to maintain its shape, in particular in filtration operation. The stabilization elements, in particular the lateral and head strips can form in this context a closed or open frame—also monolithic—which surrounds the filter material.

For the fold pack, the filter element preferably comprises two head strips and two lateral strips which are connected to the fold pack, in particular by material fusion, and surround it in a frame shape as seal sections. The lateral and head strips are formed e.g. of nonwoven material, in particular a filter nonwoven, filter fabric or laid filter. The nonwoven material of the lateral and head strips can have in particular a reduced air permeability compared to the filter medium and/or a higher bending stiffness than the filter medium.

The filter material can be folded or embodied in a corrugated shape. As folds, for example, zigzag or W folds are known. The filter material can be embossed and subsequently folded with sharp edges at embossed edges with formation of fold edges. A flat filter material sheet can be provided as starting material and correspondingly formed. The filter material is, for example, a filter fabric, a laid filter, or a filter nonwoven. In particular, the filter material can be produced by a spunbond or melt blown method. Furthermore, the filter medium can be felted or needled. The filter material can comprise natural fibers such as cotton or synthetic fibers, for example, of polyester, polyphenyl sulfide or polytetrafluoroethylene. The fibers can be oriented during production in, at a slant to and/or transversely to the machine direction.

The filter material can be of a one-layer or multi-layer configuration. It can furthermore contain an adsorption agent, for example, active carbon. Moreover, the filter material can comprise an antimicrobial and/or anti-allergenic action. As anti-microbial substance, for example, zinc pyrithione or nanosilver, as anti-allergenic substance, for example, polyphenol is conceivable.

A corresponding filter element serves for filtering fluids, i.e., gaseous and/or liquid media, for example, air. A gaseous medium or air comprises here also gas or air/solids mixtures and/or gas or air/liquid mixtures. For example, an air conditioning device can comprise the filter element.

An in particular open filter material can be designed to remove particles of the test dust A4 according to ISO 12103-1 from an air flow with a filtration rate of 0.10 to 0.30 m/s, in relation to the filter medium surface, at an air permeability of greater than 3,000 l/m²s (determined according to ISO-9237 at 200 Pa). The determination of the filtration characteristics can be realized, for example, according to DIN 71460-1.

An in particular high-separation filter material can be designed to remove particles of the test dust A2 according to ISO 12103-1 as well as NaCl aerosol particles according to DIN 71460-1 from an air flow with a filtration rate of 0.10 to 0.30 m/s, in relation to the filter medium surface, at an air permeability of greater than 600 l/m²s (determined according to ISO-9237 at 200 Pa). The determination of the filtration characteristics can be realized, for example, according to DIN 71460-1.

In embodiments, the filter material is manufactured as a synthetic medium with multi-layer construction. A grammage of the filter material amounts to preferably 50-150 g/m².

The filter material corresponds preferably to an efficiency class of E10-14 according to DIN EN 1822-3 in the version at the filing date of this application.

In variants, the fold distance is less than 5 mm. Conceivable is an embodiment of the filter element as HEPA filter. A material thickness of the filter material, in particular of a HEPA filter material, is between 0.2 mm and 1 mm, for example. In other embodiments, also significantly thicker filter materials can be used, for example, so-called combination filter media which comprise, in addition to at least one particle filter layer, a gas adsorption filter layer. The thickness can amount here to up to 2 mm or even up to 3 mm. Correspondingly, also the fold distances are to be selected larger, in particular larger than 5 mm.

The filter element respectively can be used in passenger cars, trucks, construction machines, watercraft, rail vehicles, aircraft as well as in general in air conditioning technology, in particular in heating/air conditioning devices, in domestic appliances, in fuel cells and/or in the building technology. These motor vehicles or vehicles can be operated electrically and/or by means of fuel (in particular gasoline or diesel). In respect to the building technology, in particular stationary devices for treatment of air are conceivable.

Still further, the invention concerns a vehicle with such a filter assembly.

The features described for the filter element apply to the interior air filter, the filter assembly as well as the vehicle correspondingly, and vice versa.

Further possible implementations of the invention comprise also combinations, not explicitly mentioned, of features or method steps disclosed above or in the following in relation to the embodiments. In this context, a person of skill in the art will also add individual aspects as improvements or supplements to the respective basic form of the invention.

Further embodiments of the invention are subject matter of the dependent claims as well as of the embodiments of the invention described in the following. In the following, the invention will be explained with the aid of embodiments with reference to the attached Figures in more detail.

### BRIEF DESCRIPTION OF THE DRAWINGS

FIG. 1 shows a schematic illustration of a general motor vehicle with an interior air filter.

FIG. 2 shows a perspective illustration of a filter material.

FIG. 3 shows a schematic view of a filter element according to an embodiment.

FIG. 4 shows a perspective view of a first embodiment of a filter assembly in an exploded illustration.

FIG. 5 shows a perspective view of the first embodiment in an assembled state and in a vertical section view.

FIG. 6 shows a section view of the first embodiment and detail views.

FIG. 7 shows a perspective view of a second embodiment of a filter assembly in an exploded illustration.

FIG. 8 shows a side view with a rim-side vertical section view of FIG. 7.

### PREFERRED EMBODIMENTS

FIG. 1 shows a motor vehicle 100 with an air conditioning device comprising a filter assembly 10. For example, the air conditioning device can be designed as a heating/air conditioning device. The air conditioning device or the filter assembly 10 takes up external air 11 and guides filtered air 12 to a cabin 13 (also referred to as passenger compartment) of the motor vehicle 100. The filtration is realized by means of a filter element 1 embodied as an interior air filter.

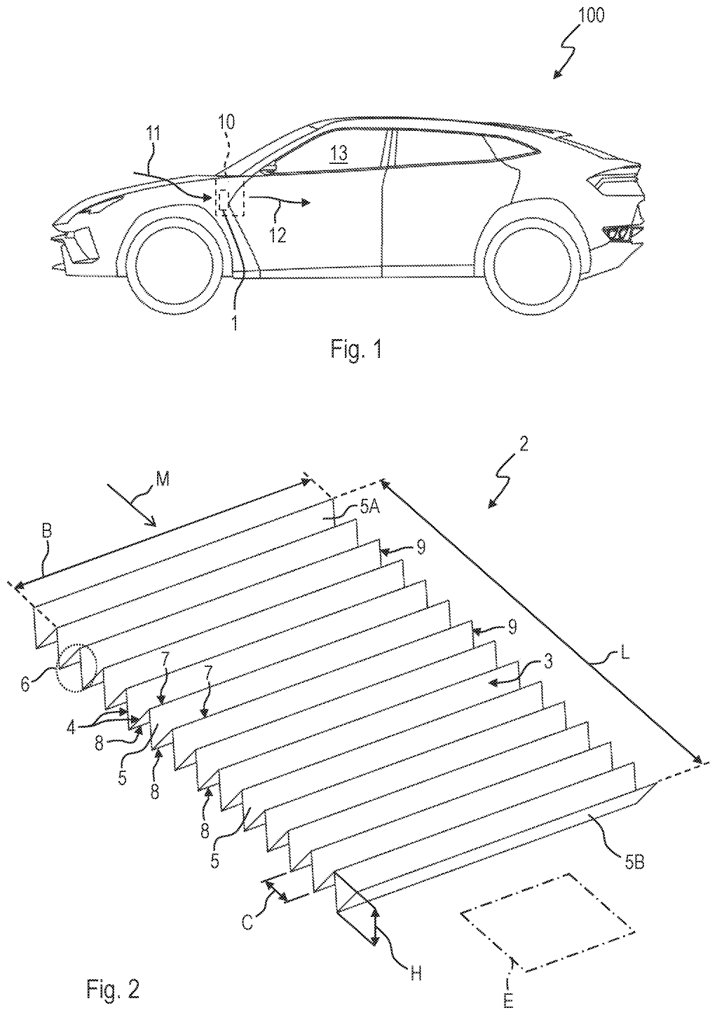

FIG. 2 shows a folded filter material 3 in isolation and can be referred to in the illustrated form as a fold pack 2. The filter material 3 is, for example, a filter nonwoven, filter fabric, laid filter, or filter felt, in particular a needle felt. In particular, the filter material 3 can be produced by a meltblown method. The filter material 3 can comprise natural fibers such as cotton or synthetic fibers, for example, of polyester, polyphenyl sulfide, or polytetrafluoroethylene. The fibers can be oriented during processing in, at a slant to and/or transversely to the machine direction M. Also, the fibers can be stretched in a spatial direction. The filter material 3 can be designed as a one-layer or multi-layer configuration.

For forming the fold pack 2, the filter material 3 comprises folds 6 which typically extend transversely to the machine direction M. The folded filter material 3 is also referred to as pleating. The folds 6 can be produced by means of folding along sharp fold edges 7, 8 (also referred to as fold tips) or by a corrugated configuration of the filter material 3. In FIG. 2, one can see top fold edges 7 and bottom-side fold edges 8 in the orientation of FIG. 2. A respective fold 6 can be defined by two neighboring fold sections 5 which are connected to each other by a corresponding fold edge 8. Folding is designed as zigzag folding. Thus, a zigzag-shaped fold profile 4, 9 at the sides of the fold pack 2 results.

Folding in which the folds 6 have a varying height H is possible also. Moreover, the fold distance C between the folds 6 or neighboring fold edges 7, 8 of identical fold orientation can vary. The filter material 3 can be designed to be self-supporting, i.e., the folds 6 are shape-stable for an intended flow in filtration operation.

The filter material 3 is delimited in machine direction M by end fold sections 5A, 5B. Transverse thereto, the filter material 3 is delimited by lateral fold end edges (also referred to as fold profiles 4, 9). “Fold end edge” means the lateral edge of the filter material 3 at the side of the fold pack 2 which extends between neighboring fold edges 7, 8 of a respective fold 6.

The filter material 3, in the plan view, i.e., in the plane E of its flat extension, can have a rectangular shape. However, also a triangular, pentagonal or polygonal, round or oval shape is conceivable.

In the illustration of FIG. 2, a length L of the fold pack 2 along the machine direction M and transverse to the fold edges 7, 8 is indicated. Along the fold edges 7, 8 and transverse to the machine direction M, a width B of the fold pack 2 is usually indicated. As a radial direction, a direction in the plane E is understood here and an axial direction is perpendicularly arranged thereto, i.e., substantially along the flow direction.

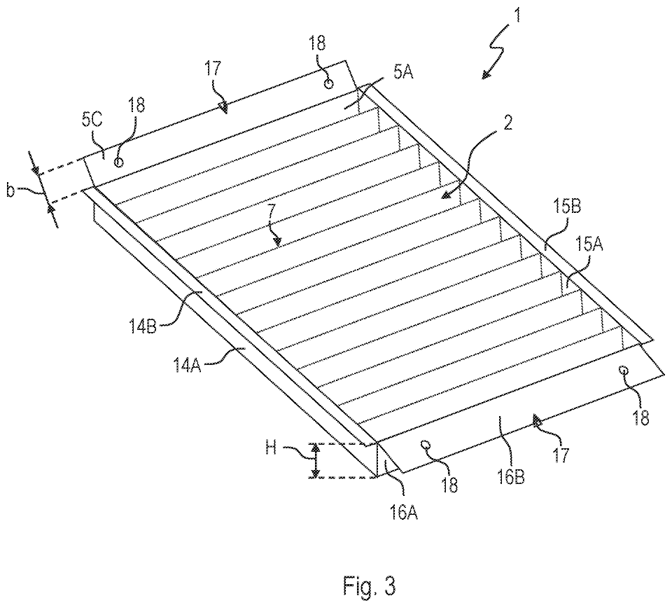

For producing a filter element, for example, an interior air filter element, a circumferential frame element is attached to the fold pack 2 illustrated in FIG. 2. In FIG. 3, the illustrated fold pack 2 of FIG. 2 is indicated with top-side fold edges 7. Lateral strips 14, 15 are attached to the fold profiles 4, 9. The lateral strips 14, 15 each have an L-profile with a section 14A, 15A, which is, for example, glued to the fold profiles 4, 9, and a laterally projecting leg 14B, 15B. The laterally projecting lateral strip sections or legs 14B, 15B serve as seal sections for lateral sealing in relation to the housing surfaces. The vertical legs 14A, 15A in the orientation of FIG. 2 correspond to the height H of the fold pack 2.

At the head side, in the orientation of FIG. 3 pointing forwardly to the right, the fold pack 2 is closed off by the head strip 16. The head strip 16 comprises again a section or leg 16A, which corresponds to the height H of the fold pack 2, and a laterally and angularly projecting leg 16B as seal section. At the head section of the fold pack 2 positioned opposite the head strip 16, which in the orientation of FIG. 3 is indicated at the top to the left, the end fold section 5A has a projecting leg 5C as seal section extending past the height H and the length L of the fold pack 2. The leg 5C is separated from the end fold section 5A by a fold edge.

While the lateral strips with the sections 14A, 15A attached to the fold profiles 4, 9 and the angled seal sections 14B, 15B are relatively stable, the head-side strips or seal sections 5C, 16B have a reduced stability originating from the fold pack 2. The fold edge serves substantially as stabilization and the seal section 5C, 16B projects past it from the respective end fold 5A or the head strip section 16A. In order to obtain an improved positioning and fastening or support of the angularly projecting seal section 5C, 16B, the seal sections 5C, 16C are provided with stamped-out portions 17, 18.

In this context, two respective holes 18 are provided in the seal section 5C, 16B, respectively, and a central notch 17. Corresponding engagement elements of a housing can engage these incisions 17 or cutouts 18. On the one hand, in this way an improved positioning and fastening of the entire filter element is obtained and, on the other hand, in the manner of a lock-and-key principle the use of unsuitable filter elements with contours or incisions/cutouts that are not matching can be prevented. In this way, the operational safety, for example, of the motor vehicle in which a corresponding filter element 1 is to be used, can be increased. Further embodiments, not explicitly mentioned, have at the head strip side either angularly projecting seal sections 16B as part of the head strip 16 or appropriately configured end fold sections 5C.

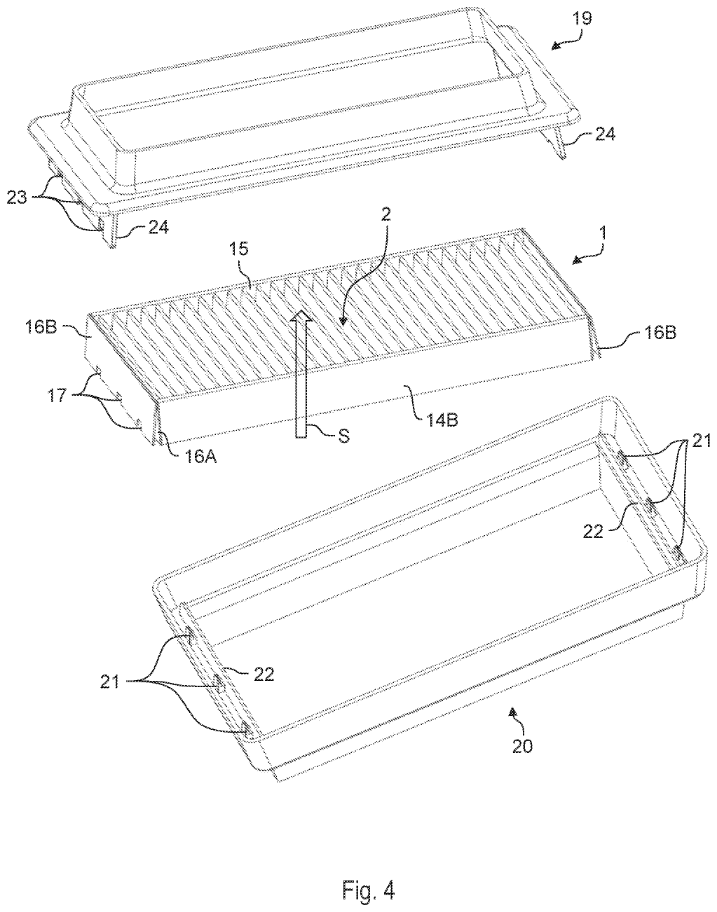

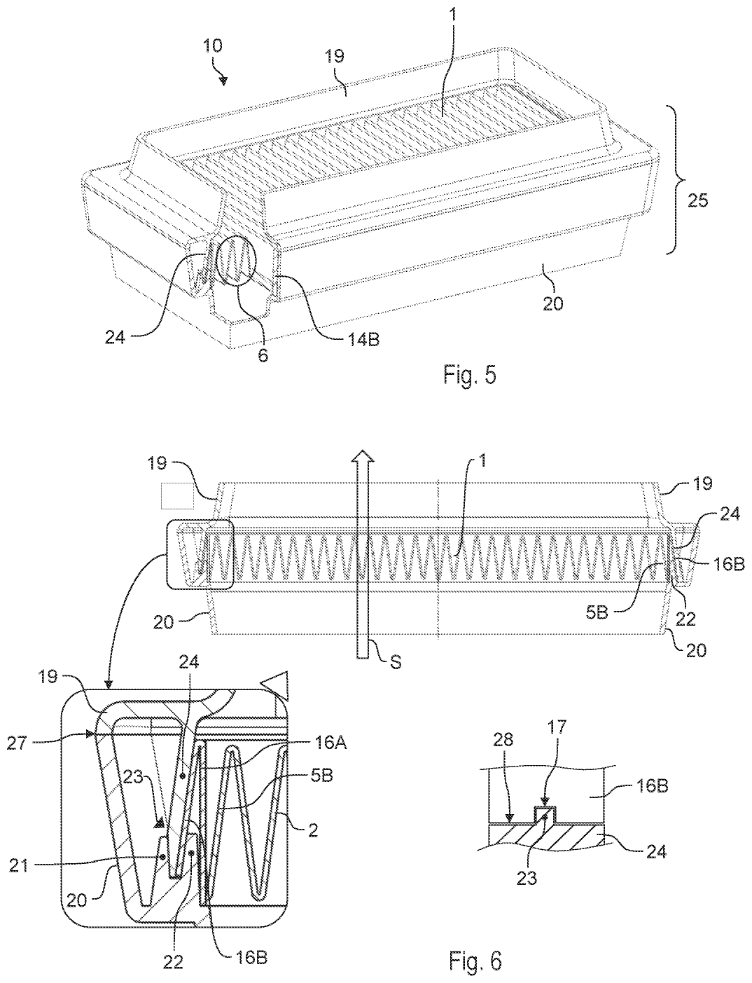

In FIGS. 4, 5, and 6, a first embodiment of a filter assembly 10 is illustrated. In this context, FIG. 4 shows a perspective view in an exploded illustration with a filter housing of two housing parts 19, 20 and a filter element 1 that can be received therein. FIG. 5 shows the filter assembly or filter device 10 in the assembled state, and FIG. 6 shows section views.

One can see in FIGS. 4 and 5 a filter housing 25 to be assembled of two housing parts 19, 20. The filter housing 25 is constructed frame-shaped and suitable to receive a cuboid filter element 1. The filter element 1 has in this context a fold pack 2, lateral strips visible in FIG. 4 of which only the leading one 14B is identified with a reference character, and two head strips 16 (16A, 16B), wherein angularly projecting sections which are radially folded over are present as seal sections 16B. The seal sections 16B have each three notches 17 that have a quadrangular shape.

The seal sections 16B are manufactured in this context of filter material and implemented as tabs or strips. The bottom housing part 20 in the orientation of FIG. 4 comprises at the head strip side of the filter element 1 two seal ridges 22 and, on each side, holders 21 oppositely positioned to the respective seal ridge 22. The top housing part 19 has also two seal ridges 24 provided for the head strip sides and comprising engagement elements 23 formed by inwardly oriented projections.

In the assembled state, as illustrated in FIG. 6, the top seal ridges 24 are guided between the bottom seal ridge 22 and the holders 21. The holders 21 correspond with the engagement elements 23 of the top seal ridge 24 so that the engagement elements (projections) 23 engage the cutouts 17 of the seal section 16B implemented as stamped-out portions. In FIG. 6 at the bottom to the left, a detail illustration is shown in which the section extends through a region in which the seal ridge 24 respectively its radially inwardly oriented projections cannot be directly seen. One can see in the section view of FIG. 6, at the bottom to the left, that the head strip section 16B functioning as seal section is clamped and seals between the seal ridge 22 of the bottom housing part 20 and the seal ridge 24 of the top housing part 19, at least in the bottom region.

Moreover, the engagement of the engagement elements (projections) 23 of the top seal strip 24, as illustrated in FIG. 6 at the bottom to the right, in the corresponding contours of the stamped-out portion 17 leads to a horizontal displacement securing action, in the orientation of FIG. 6, of the seal section 16B. In addition, it is prevented that a wrong installation position of the filter element within the housing occurs. In the illustration of FIG. 6, a rectangular incision or a stamped-out portion 17 has been carried out from an outer edge 28 of the seal section 16B. In the illustration of FIG. 4, one can see that three such cutouts or incisions 17 at the respective seal section 16B are provided, respectively. In the installed state, the seal section 16B is substantially folded over such that it extends along the flow direction S. In this context, the width of the seal section 16B can be adjusted to the housing construction, respectively.

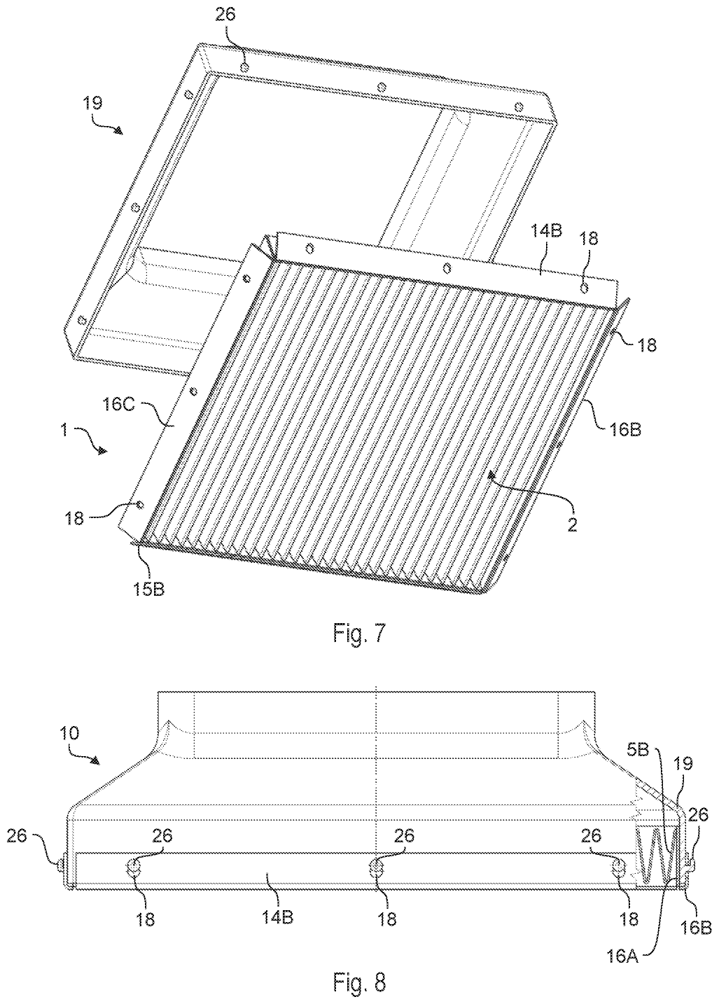

FIGS. 7 and 8 show a second embodiment of a filter assembly with seal sections extending circumferentially about a fold pack 2. FIG. 7 shows a perspective exploded view and FIG. 8 a side view with a rim-side vertical section view. In the embodiment according to FIGS. 7 and 8, the filter element 1 has a square footprint and the fold pack 2 is provided with lateral and head strips. The lateral strips 14, 15 have a lateral angularly projecting section as seal section 14B, 15B, likewise the head strips 16B, 16C. The tabs or strips 14B, 15B, 16B, 16C functioning as seal sections are provided with holes 18 which can be attached to engagement elements of the housing part 19 embodied as hooks 26.

The housing part 19 has a frame, circumferentially extending about the outer contour of the filter element, with outwardly oriented hooks 26. In FIG. 8, one can see in the installed state how the respective seal section 14B, 16B is folded over about the housing edge and from the exterior is fastened on the hooks 26 by means of the holes 18. In this context, the respective hook 26 pushes through the hole of the seal section 16B, 16C, 14B, 15B. Not all hooks and openings are provided with reference characters.

In the variant of FIGS. 7 and 8, the housing rim also serves as seal ridge from the interior against the lateral strip and head strip sections 16A secured by attachment by means of the hooks 26 and from the exterior against the seal sections 16B (compare FIG. 8, bottom right). In this way, a good sealing action without additional seal means is effected at the rim side.

By corresponding contours by incisions or cutouts at the seal section of the filter element, on the one hand, and of the housing receiving the filter element, on the other hand, in particular at the head strip side, a good sealing action, positioning, and stabilization of the filter element is obtained. Even though in the description certain geometries of corresponding contours of the incisions or cutouts and engagement elements have been explained, they can be adapted to the respective installation situation. Preferably, at least two such incisions/cutouts are provided per side of the filter element at the head strip side.

### REFERENCE CHARACTERS

1 filter element/interior air filter

2 fold pack

3 filter material

4, 9 fold profile

5 fold section

5A, 5B end fold section

5C seal section

6 folding

7, 8 fold edge

9 fold profile

10 filter device/filter assembly

11 raw air

12 filtered air

13 cabin

14 (14A, 14B) lateral strip

15 (15A, 15B) lateral strip

14B, 15B seal section

16 (16A, 16B) head strip

16C seal section

17 incision

18 cutout (hole)

19, 20 housing part

21 holder

22 seal ridge

23 engagement element

24 seal ridge

25 housing

26 hook

27 housing separation

28 edge

100 vehicle

b projection

B width

C fold distance

E plane

H height

L length

M machine direction

S flow direction

What is claimed is:

1. A filter element comprising:
a fold pack comprising a filter material folded in a zigzag shape, the fold pack comprising lateral fold profiles and an end fold section disposed at a head side of the fold pack;
lateral strips attached to the lateral fold profiles of the fold pack;
a first seal section angularly projecting at an angle away from the end fold section at the head side of the fold pack;
wherein the first seal section comprises at least one first incision or cutout, configured to receive a corresponding first filter housing contour.

2. The filter element according to claim 1, further comprising a head strip attached to the end fold section, wherein the head strip comprises the first seal section.

3. The filter element according to claim 1, wherein the first seal section is formed by the end fold section projecting past the head side.

4. The filter element according to claim 1, further comprising a second seal section projecting laterally at an angle away from a first one of the lateral strips.

5. The filter element according to claim 4, wherein the second seal section comprises at least one second incision or cutout configured to receive a corresponding second filter housing contour.

6. The filter element according to claim 4, wherein the second seal section is a section of the first one of the lateral strips and projects laterally past a width and/or past a height of the fold pack.

7. The filter element according to claim 1, wherein the first seal section is a flat material strip and the at least one first incision or cutout is a notch, a hole and/or a stamped-out portion in the flat material strip.

8. The filter element according to claim 1, further comprising a head strip attached to the fold pack at the head side, wherein the first seal section is a section of the head strip and projects laterally past a length and/or past a height of the fold pack.

9. The filter element according to claim 1, wherein the first seal section is a section of the end fold section and projects laterally past a length and/or past a height of the fold pack.

10. The filter element according to claim 1, wherein the first seal section is comprised of formed of the filter material.

11. The filter element according to claim 1, wherein the angle at which the first seal section angularly projects away from the end fold section is variable.

12. A filter assembly comprising:
a filter housing comprising a first housing part with a filter housing contour comprising at least one engagement element;
a filter element configured to be received at least partially in the filter housing, the filter element comprising:
a fold pack comprising a filter material folded in a zigzag shape, the fold pack comprising lateral fold profiles and an end fold section disposed at a head side of the fold pack;
lateral strips attached to the lateral fold profiles of the fold pack;
a seal section angularly projecting at an angle away from the end fold section at the head side of the fold pack;
wherein the seal section comprises at least one incision or cutout configured to receive the at least one engagement element of the filter housing contour.

13. The filter assembly according to claim 12, wherein the first housing part comprises a first seal ridge against which the seal section is fastened.

14. The filter assembly according to claim 13, wherein the filter housing comprises a second housing part with a second seal ridge, wherein the seal section is sealingly clamped between the first and the second seal ridges.

15. The filter assembly according to claim 12, wherein the at least one engagement element comprises a hook.
